(19) United States
(12) Patent Application Publication
(10) Pub. No.: US 2024/0068076 A1
(43) Pub. Date: Feb. 29, 2024

(54) ALUMINUM ALLOY, METHOD FOR PRODUCING AN ENGINE COMPONENT, AND ENGINE COMPONENT

(71) Applicant: FEDERAL-MOGUL NURNBERG GMBH, NURNBERG (DE)

(72) Inventors: ROMAN MORGENSTERN, HEILSBRONN (DE); RAINER WEISS, NURNBERG (DE); KLAUS LADES, NURNBERG (DE); ANDREAS HÖRAUF, STEIN (DE); ROBERT WILLARD, NURNBERG (DE); THOMAS KIRSTE, BURGTHANN (DE)

(21) Appl. No.: 18/245,782

(22) PCT Filed: Sep. 1, 2021
(86) PCT No.: PCT/EP2021/074121

§ 371 Date: Nov. 17, 2023

(30) Foreign Application Priority Data
Sep. 17, 2020 (DE) 10 2020 211 653.9

(51) Int. Cl. C22C 21/02; C22F 1/043; F02F 3/00

(52) U.S. Cl. CPC C22C 21/02; C22F 1/043; F02F 3/0084

(57) ABSTRACT

The present application relates to an aluminum alloy, in particular a cast aluminum alloy, a method for producing an engine component, in particular a piston for an internal combustion engine, in which an aluminum alloy is cast using the gravity die casting method, and an engine component, in particular a piston for an internal combustion engine, consisting at least partially of an aluminum alloy. The aluminum alloy consists of the following alloy elements:
silicon: 10% by weight to <13% by weight,
nickel: up to <0.6% by weight,
copper: 1.5% by weight to <3.6% by weight,
magnesium: 0.5% by weight to 1.5% by weight,
iron: 0.1% by weight to 0.7% by weight,
manganese: 0.1 to 0.4% by weight,
zirconium: >0.1 to <0.3% by weight,
vanadium: >0.08 to <0.2% by weight,
titanium: 0.05 to <0.2% by weight,
phosphorus: 0.0025 to 0.008% by weight,
   and the remainder being aluminum and unavoidable impurities. Furthermore, the microstructure of the alloy has spheroidized primary precipitates.

### BACKGROUND

### 1. Technical Field

The present invention relates to an aluminum alloy, a method for producing an engine component, and an engine component consisting at least partially of an aluminum alloy.

### 2. Related Art

Driven by the economic and ecological demand for consumption- and emission-optimized means of transport, the last 15 years have seen a rapid development of ever more powerful and lower-emission engines. A decisive key for this continuous progress is pistons that can be used at ever higher combustion temperatures and pressures, while still being of low weight. This is essentially made possible by the development of higher-performance piston materials.

It is known from the prior art that pistons are produced in series by gravity die casting. Furthermore, quenching of pistons in water and artificial aging for several hours in an oven are generally known.

DE 10 2011 083 969 A1 discloses in this regard a method for producing an engine component, in particular a piston for an internal combustion engine, in which an aluminum alloy is cast using the gravity die casting method. The aluminum alloy thereby comprises the following alloy elements: silicon: 6% by weight to 10% by weight, nickel: 1.2% by weight to 2% by weight, copper: 8% by weight to 10% by weight, magnesium: 0.5% by weight to 1.5% by weight, iron: 0.1% by weight to 0.7% by weight, manganese: 0.1% by weight to 0.4% by weight, zirconium: 0.2% by weight to 0.4% by weight, vanadium: 0.1% by weight to 0.3% by weight, titanium: 0.1% by weight to 0.5% by weight. Here, high concentrations of the expensive element copper are required in order to produce the high-temperature resistant alloy.

DE 10 2018 210 007 A1 discloses an aluminum alloy comprising the following alloy elements in addition to aluminum and unavoidable impurities: silicon: 10% by weight to <13% by weight, nickel: up to <0.6% by weight, copper: 1.5% by weight to <3.6% by weight, magnesium: 0.5% by weight to 1.5% by weight, iron: 0.1% by weight to 0.7% by weight, manganese: 0.1 to 0.4% by weight, zirconium: >0.1 to <0.3% by weight, vanadium: >0.08 to <0.2% by weight, titanium: 0.05 to <0.2% by weight, and phosphorus: 0.0025 to 0.008% by weight. However, the microstructure of the alloy does not have the primary precipitates spheroidized therein according to the invention, which are the cause of the significantly improved web strength in the pistons made from an alloy according to the invention.

### SUMMARY

Against this background, a lightweight yet high-temperature resistant cast aluminum alloy is provided with a casting process and heat treatment adapted to this. In particular, the microstructural distribution, morphology, composition and thermal stability of all phases play a special role here. The optimization of the microstructure should be carried out taking into account a minimum content of pores and oxidic inclusions.

The sought-after piston material should be optimized primarily in terms of its density, but also in terms of isothermal fatigue strength (High Cycle Fatigue, HCF) and thermomechanical fatigue strength (Thermo Mechanical Fatigue, TMF). Under TMF stress, microplasticities and/or microcracks, which can considerably reduce the lifespan of the piston material, occur at relatively large primary phases, in particular at primary silicon precipitates, owing to the different coefficients of expansion of the individual components of the alloy, namely the matrix and the primary phases. In order to increase the lifespan, it is therefore advantageous to keep the primary phases as small as possible. In summary, in order to improve the TMF properties of the piston material, a fine microstructure should be aimed at that reduces the potential for microplasticity or microcrack formation at relatively large primary phases (especially primary silicon precipitates) and thus reduces the susceptibility to crack initiation and propagation. In particular, the material should also have a high resistance to so-called web fractures.

The addition of strength-increasing, but heavy and expensive elements such as copper and nickel particularly increases the density of the piston material and thus the weight of the piston. Here, it is always necessary to find a compromise between density, strength and cost.

As with pressure die casting, however, there is also an upper concentration limit for gravity die casting up to which alloy elements should be introduced and above which the castability of the alloy is made difficult or impossible. Moreover, too high concentrations of strength-increasing elements result in the formation of large plate-shaped intermetallic phases that drastically reduce fatigue strength (particularly HCF, but also TMF).

### DESCRIPTION OF THE INVENTION

In view of the challenges described, one object is therefore to provide an aluminum alloy that can be cast by gravity die casting, has a low density and nevertheless contains an increased proportion of finely dispersed, high-temperature resistant, thermally stable phases and also has silicon precipitates in an advantageous form, preferably in the bowl edge region or bottom region that is subjected to high thermal stress. Furthermore, it is an object to significantly increase the web strength of pistons made from the cited alloy.

An aluminum alloy, in particular a cast aluminum alloy, consisting of the alloy elements
silicon: 10% by weight to <13% by weight,
nickel: up to <0.6% by weight,
copper: 1.5% by weight to <3.6% by weight,
magnesium: 0.5% by weight to 1.5% by weight,
iron: 0.1% by weight to 0.7% by weight,
manganese: 0.1 to 0.4% by weight,
zirconium: >0.1 to <0.3% by weight,
vanadium: >0.08 to <0.2% by weight,
titanium: 0.05 to <0.2% by weight,
phosphorus: 0.0025 to 0.008% by weight,
   and the remainder being aluminum and unavoidable impurities, has particularly favorable properties as regards high-temperature strength and is suitable for the production of weight-reduced, heavy-duty pistons for internal combustion engines due to the density that is reduced compared to the prior art.

The contents of copper and nickel that are significantly reduced compared to the prior art on the one hand advantageously reduce the overall costs of alloy production since they are among the most expensive alloy elements, and thus any (partial) substitution or reduction of the contents of these two elements leads to considerable cost savings. On the other hand, this reduces the density of the aluminum material. Owing to the optimum adjustment of the alloy elements magnesium, iron, manganese, zirconium, vanadium and titanium, good and sufficient strength is nevertheless ensured despite the significant reduction in the contents of the elements copper and nickel that are otherwise necessary to withstand high thermal stresses. The silicon content serves to achieve good castability of the aluminum material.

A central aspect of the aluminum alloy is the rounding or spheroidizing of the primary precipitates in the microstructure. This spheroidizing is the result of a specially adapted heat treatment and leads to significantly improved ductility as well as higher strength at low temperatures. As a result, the use of such an alloy in the production of pistons thus leads to improved web strength. The rounding or spheroidizing according to the invention of the primary precipitates is characterized in that the primary precipitates contained in the alloy have an average roundness of >0.47. The roundness (circularity) is determined in accordance with the following equation:

C=(4πA/P²)

Here, C describes the circularity of the respective precipitate, A designates the area of the precipitate, and P designates the perimeter of the precipitate.

Furthermore, the cited heat treatment advantageously also results in a rounding of the intermetallic phases, which preferably have an average roundness of >0.44.

The above alloy contains only the listed components and unavoidable impurities, i.e. components in low concentration that have not been deliberately added as functional components. The alloy according to the invention is in particular free of beryllium (Be) and/or calcium (Ca).

Furthermore, it is preferred that the aluminum alloy or cast aluminum alloy according to the invention contains 11.0 to <12.5 of silicon and/or 1.8 to <2.6% by weight of copper and/or 0.8% by weight to 1.2% by weight of magnesium and/or 0.4% by weight to 0.6% by weight of iron. Advantageously, the aluminum alloy or cast aluminum alloy according to the invention has an iron/manganese ratio of 2:1 and preferably between 2:1 and 5:1 and/or a sum of the contents of iron and manganese not exceeding 0.9% by weight. The concentration ranges mentioned represent an optimum compromise in the area of conflict between the essential factors of material properties, weight/density and cost.

Another aspect lies in the method for producing an engine component, in particular a piston for an internal combustion engine, wherein the aforementioned aluminum alloy is cast using the gravity die casting method and the resulting casting is then subjected to a heat treatment at 470° C. to 530° C. for a period of 30 minutes to 8 hours. This heat treatment provides the desired rounding/spheroidizing of the primary precipitates, which as a result ensures the improved ductility and strength and ultimately the improved web strength in the production of a piston. A particularly advantageous synergistic effect is achieved by combining the aforementioned heat treatment with the alloy elements titanium, zirconium and vanadium in the concentrations according to the invention, since these elements maintain the network of primary phases and thus lead to improved mechanical properties at high temperatures.

Particularly advantageous microstructures can be achieved at temperatures between 490° C. and 515° C., particularly preferably between 505° C. and 515° C., and/or with heat treatment periods between one hour and three hours.

Advantageously, the heat treatment is followed, preferably immediately, by quenching below the lowest limit of the aging temperature within a period of 2 seconds to 2 minutes. The lowest limit of the aging temperature is 160° C.

According to an advantageous embodiment, after the heat treatment, preferably following quenching, the casting is aged in the temperature range of 160° C. to 250° C. for a period of 3 hours to 36 hours, preferably up to 20 hours. On the one hand, this aging ensures sufficient thermal stability without piston seizure during engine operation, but on the other hand it also ensures high initial hardness and thus strength in colder regions of the engine component.

Aging temperatures of 200° C. to 235° C., preferably 210° C. to 235° C., and/or aging periods between 4 hours and 15 hours, preferably between 8 hours and 15 hours, have proven to be particularly advantageous.

An engine component, in particular a piston for an internal combustion engine, preferably consists at least partially of one of the aforementioned aluminum alloys according to the invention. Such an engine component exhibits improved (high-temperature) strength, ductility and web strength.

1-15. (canceled)

16. Aluminum alloy, in particular cast aluminum alloy, the aluminum alloy consisting of the following alloy elements:
silicon: 10% by weight to <13% by weight,
nickel: up to <0.6% by weight,
copper: 1.5% by weight to <3.6% by weight,
magnesium: 0.5% by weight to 1.5% by weight,
iron: 0.1% by weight to 0.7% by weight,
manganese: 0.1 to 0.4% by weight,
zirconium: >0.1 to <0.3% by weight,
vanadium: >0.08 to <0.2% by weight,
titanium: 0.05 to <0.2% by weight,
phosphorus: 0.0025 to 0.008% by weight,
and the remainder being aluminum and unavoidable impurities, wherein the microstructure of the alloy comprises rounded primary precipitates having an average roundness of >0.47.

17. The aluminum alloy according to claim 16, wherein the silicon content is between 11% by weight to <12.5% by weight.

18. The aluminum alloy according to claim 16, wherein the copper content is between 1.8% by weight to <2.6% by.

19. The aluminum alloy according to claim 16, wherein the magnesium content is between 0.8% by weight to 1.2%.

20. The aluminum alloy according to claim 16, wherein the iron content is between 0.4% by weight to 0.6% by weight.

21. The aluminum alloy according to one claim 16 wherein the ratio of iron to manganese is between 2:1 and 5:1.

22. The aluminum alloy according to claim 16, wherein the sum of the contents of iron and manganese does not exceed 0.9% by weight.

23. A method for producing an engine component for an internal combustion engine, including casting an engine component out of an aluminum alloy having the chemical composition according to claim 16 using a gravity die casting method and thereafter heat treating the cast engine component at 470° C. to 530° C. for a period of 30 minutes to 8 hours.

24. The method for producing an engine component according to claim 23, wherein the heat treatment is carried out at 490° C. to 515° C.

25. The method for producing an engine component according to claim 23, wherein the heat treatment is between one hour and 3 hours.

26. The method for producing an engine component according to claim 23, wherein following the heat treatment, the cast component is quenched to a temperature below 160° C. within a period of 2 seconds to 2 minutes.

27. The method for producing an engine component according to claim 23, wherein after the heat treatment, the cast component is aged in the temperature range of 160° C. to 250° C. for a period of 3 hours to 36 hours.

28. The method for producing an engine component according to claim 27, wherein the aging is carried out at 200° C. to 235° C.

29. The method for producing an engine component according to claim 27, wherein the period for aging is between 4 hours and 15 hours.

30. An engine component fabricated of an aluminum alloy according to claim 16.

31. The method for producing an engine component for an internal combustion engine according to claim 16, wherein the engine component is a piston.

32. The method for producing an engine component for an internal combustion engine according to claim 24, wherein the heat treatment is carried out at 505° C. to 515° C.

33. The method for producing an engine component for an internal combustion engine according to claim 27, wherein before aging, the casting component is first quenched to below 160° C. within a period of 2 seconds to 2 minutes following the heat treatment step.

34. The method for producing an engine component for an internal combustion engine according to claim 27, wherein the aging step is carried out for up to 20 hours.

35. The method for producing an engine component for an internal combustion engine according to claim 28, wherein the aging is carried out at 210° C. to 235° C.

36. The method for producing an engine component for an internal combustion engine according to claim 29, wherein the aging is carried out between 8 hours and 15 hours.

37. The engine component of claim 30, wherein the engine component is a piston for an internal combustion engine.
